(19) United States
(12) Patent Application Publication
(10) Pub. No.: US 2024/0269853 A1
(43) Pub. Date: Aug. 15, 2024

(54) CALIBRATION METHOD, CALIBRATION DEVICE, AND ROBOTIC SYSTEM

(71) Applicant: SEIKO EPSON CORPORATION, Tokyo (JP)

(72) Inventor: Kazufumi OYA, MATSUMOTO-SHI (JP)

(21) Appl. No.: 18/436,040

(22) Filed: Feb. 8, 2024

(30) Foreign Application Priority Data
Feb. 10, 2023 (JP) 2023-018979

(51) Int. Cl. B25J 9/16; G06T 7/73

(52) U.S. Cl. CPC B25J 9/1692; B25J 9/1697; G06T 7/74; G06T 2207/30204

(57) ABSTRACT

A calibration method includes: a fixed camera coordinate acquisition step for detecting a position of each reference marker in a fixed camera coordinate system set in the fixed camera, from fixed camera imaging data obtained by imaging a plurality of reference markers with the fixed camera; a robot coordinate acquisition step for detecting a position of each reference marker in a robot coordinate system, from robot camera imaging data obtained by imaging a plurality of reference markers with a robot camera that is mounted on a robot and that has been calibrated with a robot coordinate system set in the robot; and a calibration step of associating the fixed camera coordinate system and the robot coordinate system based on the positions of the reference markers in the fixed camera coordinate system and the positions of the reference markers in the robot coordinate system.

### CROSS-REFERENCE TO RELATED APPLICATIONS

The present application is based on, and claims priority from JP Application Serial Number 2023-018979, filed Feb. 10, 2023, the disclosure of which is hereby incorporated by reference herein in its entirety.

### BACKGROUND OF THE INVENTION

### 1. Technical Field

The present disclosure relates to a calibration method, a calibration device, and a robotic system.

### 2. Related Art

In the calibration method described in JP-A-8-210816, first, a reference point on a calibration jig is touched up by visual observation with a touch-up hand to acquire a position of the calibration jig in a robot coordinate system, and then a coordinate conversion matrix between the robot coordinate system and the calibration jig coordinate system is obtained. Next, the calibration jig is imaged by a camera mounted on the robot, and a coordinate transformation matrix between the calibration jig coordinate system and the camera coordinate system is obtained from the imaged image data.

In the calibration method described in JP-A-8-210816, since the touch-up hand is touched up to the reference point on the calibration fixture by visual observation, there is a concern that variations may occur depending on the operator. For this reason, the calibration accuracy decreases or varies.

### SUMMARY OF THE INVENTION

A calibration method, according to the present disclosure, includes a fixed camera coordinate acquisition step to detect a position of each reference marker in a fixed camera coordinate system set in a fixed camera from fixed camera imaging data obtained by imaging a plurality of reference markers with the fixed camera, a robot coordinate acquisition step for detecting a position of each reference marker in a robot coordinate system, from robot camera imaging data obtained by imaging a plurality of reference markers with a robot camera that is mounted on a robot and that has been calibrated with a robot coordinate system set in the robot, and a calibration step of associating the fixed camera coordinate system and the robot coordinate system based on the positions of the reference markers in the fixed camera coordinate system and the positions of the reference markers in the robot coordinate system.

A calibration device according to the present disclosure, is a calibration device that associates a fixed camera coordinate system set in a fixed camera with a robot coordinate system in a robotic system, the robotic system including a robot, a robot camera that is mounted on the robot and that has been calibrated using a robot coordinate system set in the robot, and the fixed camera, the calibration device: detecting a position of each reference marker in the fixed camera coordinate system, from fixed camera imaging data obtained by imaging a plurality of reference markers with the fixed camera, detecting a position of each reference marker in the robot coordinate system from robot camera imaging data obtained by imaging the plurality of reference markers with the robot camera, and associating the fixed camera coordinate system and the robot coordinate system with each other based on positions of the reference markers in the fixed camera coordinate system and positions of the reference markers in the robot coordinate system.

The robotic system according to the present disclosure, includes a robot, a robot camera mounted on the robot and calibrated with a robot coordinate system set in the robot, a fixed camera, and a calibration device that associates a fixed camera coordinate system set in the fixed camera with the robot coordinate system wherein the calibration device: detects a position of each reference marker in the fixed camera coordinate system from fixed camera imaging data obtained by imaging a plurality of reference markers with the fixed camera, detects a position of each reference marker in the robot coordinate system from robot camera imaging data obtained by imaging the plurality of reference markers with the robot camera, associates the fixed camera coordinate system and the robot coordinate system with each other based on positions of the reference markers in the fixed camera coordinate system and positions of the reference markers in the robot coordinate system.

### BRIEF DESCRIPTION OF DRAWINGS

FIG. 1 is an overall configuration diagram of a robotic system according to a preferred embodiment.

FIG. 2 is a flow chart showing the calibration method.

FIG. 3 shows an example of the reference marker.

FIG. 4 is an example of fixed camera imaging data acquired by the fixed camera.

FIG. 5 is a diagram illustrating an example of robot camera imaging data acquired by the robot camera.

### DETAILED DESCRIPTION OF THE INVENTION

Hereinafter, a calibration method, a calibration device, and a robotic system according to the disclosure will be described in detail based on preferred embodiments illustrated in the accompanying drawings.

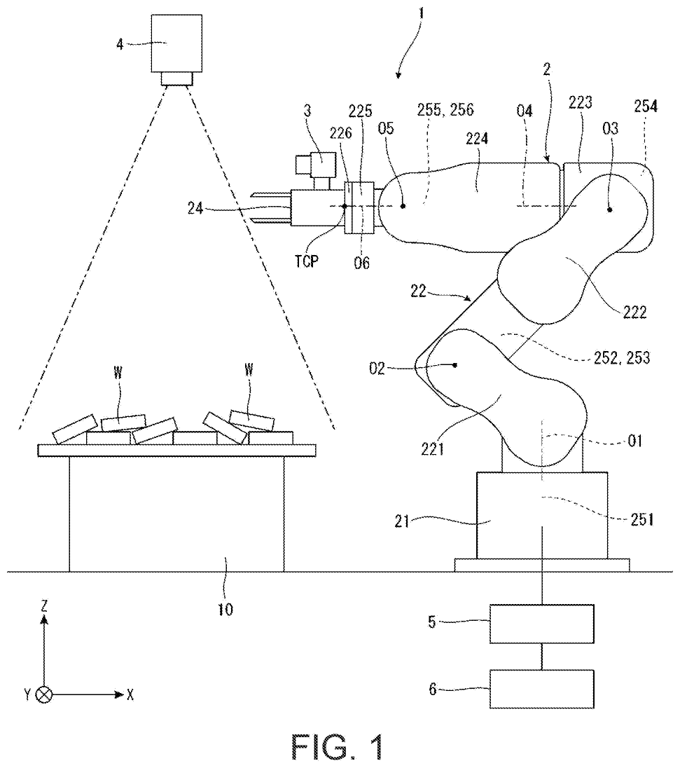

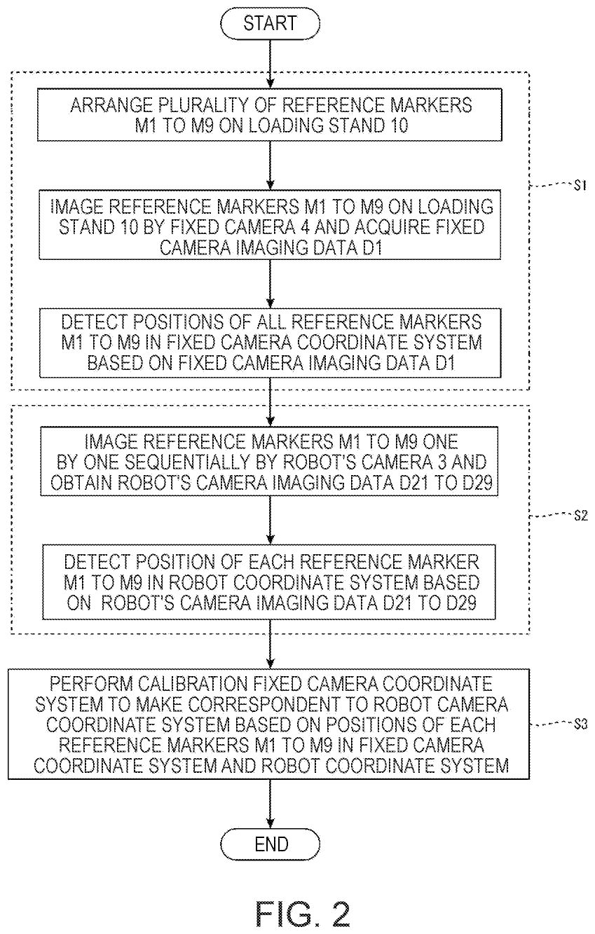

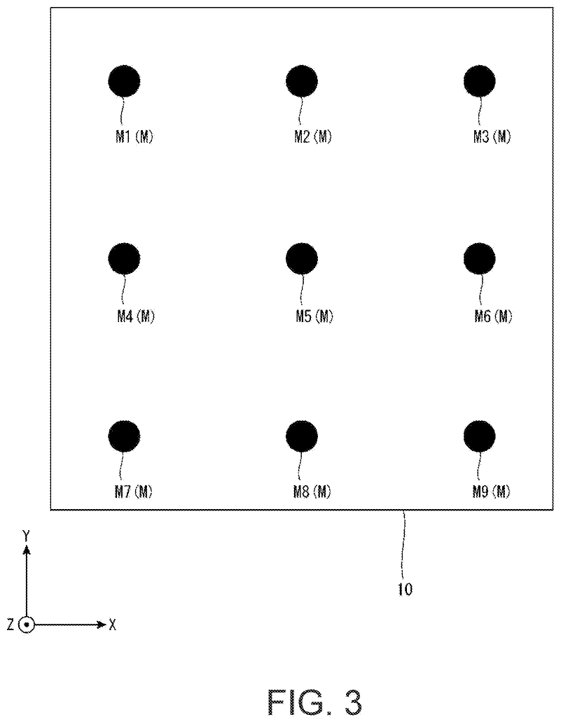

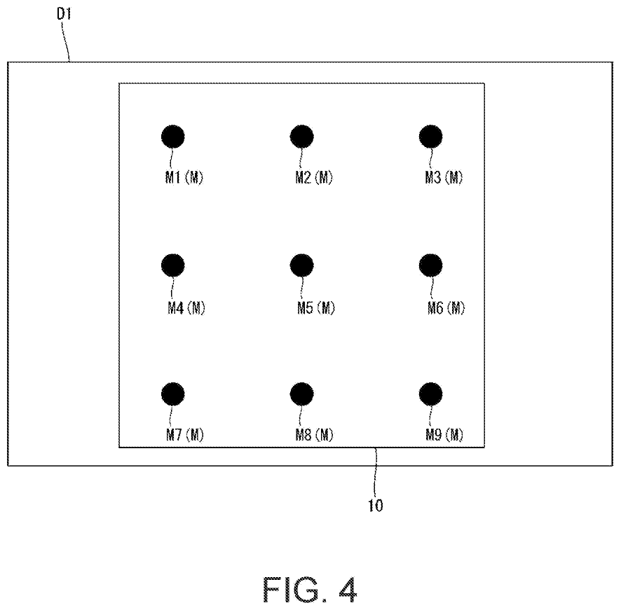

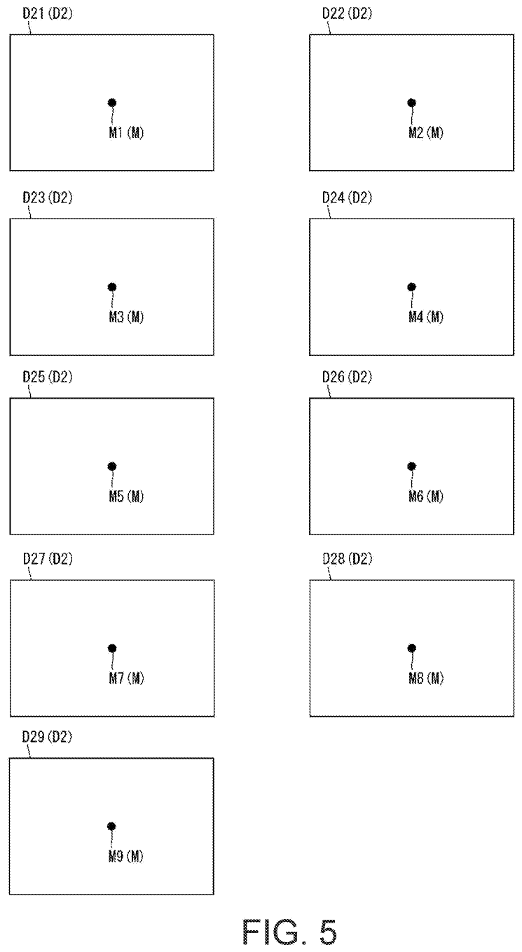

FIG. 1 is an overall configuration diagram of a robotic system according to a preferred embodiment. FIG. 2 is a flow chart showing the calibration method. FIG. 3 shows an example of the reference marker. FIG. 4 is an example of fixed camera imaging data acquired by the fixed camera. FIG. 5 is a diagram illustrating an example of robot camera imaging data acquired by the robot camera.

A robotic system 1 illustrated in FIG. 1 includes a robot 2, a robot's camera 3 mounted on the robot 2, a fixed camera 4 fixed in a space, a control device 5 that controls drive of the robot 2 based on an image captured by the fixed camera 4, and a calibration device 6 that performs calibration of the fixed camera 4 and the robot 2. These units can communicate with each other in a wired or wireless manner. Communication may be over a network such as the Internet. In such the robotic system 1, first, calibration between the fixed camera 4 and the robot 2 is performed using the calibration device 6. The fixed camera 4 images the workpiece W, which is placed in a random manner on a loading stand 10, the position and posture (hereinafter referred to as “position and posture”) of the workpiece W on the loading stand 10 are recognized based on the image data, and the recognized workpiece W is picked up by the robot 2. However, the work performed by the robotic system 1 is not particularly limited.

### Robot 2

The robot 2 is a six-axis robot having six rotation axes, and includes a base 21 fixed to a floor, a ceiling, or the like, and a robot arm 22 connected to the base 21. The robot arm 22 includes a first arm 221 rotatably coupled to the base 21 about a first rotation axis O1, a second arm 222 rotatably coupled to the first arm 221 about a second rotation axis O2, a third arm 223 rotatably coupled to the second arm 222 about a third rotation axis O3, a fourth arm 224 rotatably coupled to the third arm 223 about a fourth rotation axis O4, a fifth arm 225 rotatably coupled to the fourth arm 224 about a fifth rotation axis O5, and a sixth arm 226 rotatably coupled to the fifth arm 225 about a sixth rotation axis O6.

A tool 24 is attached to the distal end section of the sixth arm 226. The tool 24 can be appropriately selected according to the work to be executed by the robot 2 and in the present embodiment, it is a hand having a pair of claws that are openable and closable. In the robot 2, a tool center point (hereinafter, also referred to as “TCP”) as a control point is set at the distal end section of the robot arm 22. The position and posture on the TCP serve as references for the position and posture of the tool 24. However, the position of the TCP is not particularly limited, and can be appropriately set.

The robot 2 includes a first drive device 251 for rotating the first arm 221 with respect to the base 21, a second drive device 252 for rotating the second arm 222 with respect to the first arm 221, a third drive device 253 for rotating the third arm 223 with respect to the second arm 222, a fourth drive device 254 for rotating the fourth arm 224 with respect to the third arm 223, a fifth drive device 255 for rotating the fifth arm 225 with respect to the fourth arm 224, and a sixth drive device 256 for rotating the sixth arm 226 with respect to the fifth arm 225. Each of the first to sixth driving devices 251 to 256 includes, for example, a motor, a controller that controls drive of the motor, and an encoder that detects the amount of rotation of the motor. The control device 5 independently controls drive of the first to sixth driving devices 251 to 256.

A robot coordinate system used for controlling drive of the robot 2 is set in the robot 2. The robot coordinate system is a 3D orthogonal coordinate system defined by an X-axis, a Y-axis, and a Z-axis, which are orthogonal to each other. In the present embodiment, the orthogonal coordinate system is set such that the Z-axis is along the vertical direction.

The robot 2 has been described above, but the robot 2 is not particularly limited. For example, the number of arms included in the robot arm 22 may be one to five or seven or more. The robot 2 may be, for example, a SCARA robot (horizontal articulated robot) or a dual-arm robot having two robot arms 22.

### Robot's Camera 3

The robot's camera 3 is mounted on the tool 24 of the robot 2, and images the tip end side of the tool 24. The robot's camera 3 is disposed so as to be offset with respect to the sixth rotation axis O6, and the optical axis thereof is along the sixth rotation axis O6. The robot's camera 3 is a digital camera that includes a lens and an area image sensor. A robot camera coordinate system is set in the robot's camera 3. The calibration between the robot camera coordinate system and the robot coordinate system has already been performed. Therefore, the position of the target object in the image data captured by the robot's camera 3 can be specified in the robot coordinate system.

Although the robot's camera 3 has been described above, the configuration and arrangement of the robot's camera 3 are not particularly limited.

### Fixed Camera 4

As shown in FIG. 1, the fixed camera 4 is fixed in a space above the loading stand 10, and images the workpiece W on the loading stand 10. The fixed camera 4 is a digital camera that includes a lens and an area image sensor. A fixed camera coordinate system is set in the fixed camera 4. As described above, in order to recognize the position of the workpiece W on the loading stand 10 based on the imaging data captured by the fixed camera 4 and to control drive of the robot 2 based on the recognition result, it is necessary to calibrate the fixed camera coordinate system and the robot coordinate system. The details of this calibration method will be described later.

Although the fixed camera 4 has been described above, its configuration and arrangement are not particularly limited.

### Control Device 5

The control device 5 controls drive of the robot 2, the robot's camera 3, and the fixed camera 4. The control device 5 is constituted by, for example, a computer, and includes a processor that processes information, a memory that is communicably coupled to the processor, and an external interface. Various programs executable by the processor are stored in the memory, and the processor reads and executes the various programs and the like stored in the memory.

Although the control device 5 is arranged outside the robot 2 in the illustrated configuration, the arrangement of the control device 5 is not particularly limited, and for example, a part or all of the control device 5 may be housed in the robot 2.

### Calibration Device 6

The calibration device 6 calibrates between the fixed camera coordinate system set in the fixed camera 4 and the robot coordinate system set in the robot 2. The calibration device 6 is constituted by, for example, a computer, and includes a processor that processes information, a memory that is communicably coupled to the processor, and an external interface. Various programs executable by the processor are stored in the memory, and the processor reads and executes the various programs and the like stored in the memory.

In the present embodiment, the calibration device 6 and the control device 5 are separately arranged, but the present disclosure is not limited thereto. For example, the control device 5 may also serve as the calibration device 6.

Next, a calibration method between the fixed camera coordinate system and the robot coordinate system by the calibration device 6 will be described. As shown in FIG. 2, the calibration method includes a fixed camera coordinate acquisition step S1, a robot coordinate acquisition step S2, and a calibration step S3.

### Fixed Camera Coordinate Acquisition Step S1

First, as shown in FIG. 3, a plurality of reference markers M are arranged on the loading stand 10. Note that in the illustrated example, nine reference markers M1, M2, M3, M4, M5, M6, M7, M8, and M9 are arranged in the form of a 3×3 matrix, however, the number and arrangement of the reference markers M are not particularly limited. The reference markers M may be printed, stuck, or the like on the loading stand 10, or a sheet on which the reference markers M are printed, stuck, or the like may be mounted on the loading stand 10. The arrangement of the reference markers M is not particularly limited, for example, the reference markers M may be arranged on the floor.

Next, as shown in FIG. 4, the reference markers M1 to M9 on the loading stand 10 are imaged by the fixed camera 4. By this, the fixed camera imaging data D1 in which all of the reference markers M1 to M9 are imaged is obtained. In this way, by imaging all the reference markers M1 to M9 by one visual field and acquiring the fixed camera imaging data D1 in which all the reference markers M1 to M9 are imaged, it is possible to shorten the time required for the fixed camera coordinate acquisition step S1.

Next, the positions of all the reference markers M1 to M9 in the fixed camera coordinate system are detected based on the fixed camera imaging data D1.

Although the fixed camera coordinate acquisition step S1 has been described above, the fixed camera coordinate acquisition step S1 is not particularly limited. For example, the reference markers M1 to M9 may be divided into a plurality of pieces of fixed camera imaging data D1 and captured.

### Robot Coordinate Acquisition Step S2

In the robot coordinate acquisition step S2, first, the robot's camera 3 sequentially images the reference markers M1 to M9 one by one while moving the robot 2. In other words, the reference markers M1 to M9 are imaged in different visual fields. Thus, as shown in FIG. 5, a total of nine pieces of robot camera imaging data D2 are obtained, specifically, a robot camera imaging data D21 in which the reference marker M1 is captured, a robot camera imaging data D22 in which the reference marker M2 is captured, a robot camera imaging data D23 in which the reference marker M3 is captured, a robot camera imaging data D24 in which the reference marker M4 is captured, a robot camera imaging data D25 in which the reference marker M5 is captured, a robot camera imaging data D26 in which the reference marker M6 is captured, a robot camera imaging data D27 in which the reference marker M7 is captured, a robot camera imaging data D28 in which the reference marker M8 is captured, and a robot camera imaging data D29 in which the reference marker M9 is captured.

Next, the position of the reference marker M1 in the robot coordinate system is detected based on the robot camera imaging data D21, the position of the reference marker M2 in the robot coordinate system is detected based on the robot camera imaging data D22, the position of the reference marker M3 in the robot coordinate system is detected based on the robot camera imaging data D23, the position of the reference marker M4 in the robot coordinate system is detected based on the robot camera imaging data D24, the position of the reference marker M5 in the robot coordinate system is detected based on the robot camera imaging data D25, the position of the reference marker M6 in the robot coordinate system is detected based on the robot camera imaging data D26, the position of the reference marker M7 in the robot coordinate system is detected based on the robot camera imaging data D27, the position of the reference marker M8 in the robot coordinate system is detected based on the robot camera imaging data D28 and the position of the reference marker M9 in the robot coordinate system is detected based on the robot camera imaging data D29.

In this embodiment, the robot camera imaging data D21 to D29 in which the reference markers M1 to M9 are positioned at the center of the visual field of the robot's camera 3 are obtained. As described above, although the calibration between the robot camera coordinate system and the robot coordinate system has been completed, the accuracy is highest at the center of the visual field of the robot's camera 3. Therefore, by positioning each reference marker M1 to M9 at the center portion of the visual field of the robot's camera 3, it is possible to more accurately detect the position of each reference marker M1 to M9 in the robot coordinate system. It is possible to position each reference marker M1 to M9 at the center portion of the visual field of the robot's camera 3 by separately imaging each reference marker M1 to M9.

Although the robot coordinate acquisition step S2 has been described above, the robot coordinate acquisition step S2 is not particularly limited. For example, a plurality of reference markers M may be imaged in one visual field. The reference markers M1 to M9 may not be positioned at the central portion of the visual field of the robot's camera 3.

### Calibration Step S3

In the calibration step S3, calibration is performed to associate the fixed camera coordinate system with the robot coordinate system based on the positions of the reference markers M1 to M9 in the fixed camera coordinate system obtained in the fixed camera coordinate acquisition step S1 and the respective positions of the reference markers M1 to M9 in the robot camera coordinate system obtained in the robot coordinate acquisition step S2. Specifically, the positions of the reference markers M are the same in the fixed camera coordinate acquisition step S1 and the robot coordinate acquisition step S2. Therefore, the calibration between the fixed camera coordinate system and the robot coordinate system is performed by making the fixed camera coordinates of the reference markers M1 to M9 correspond to the respective robot coordinates.

The calibration method for the fixed camera coordinate system and the robot coordinate system was described above. According to such a calibration method, since a touch-up operation as in the related art is not necessary, variation due to an operator does not occur. Therefore, it is possible to effectively suppress decreases or variations in the calibration accuracy.

In the present embodiment, the robot coordinate acquisition step S2 is performed after the fixed camera coordinate acquisition step S1, but the present disclosure is not limited thereto, and the fixed camera coordinate acquisition step S1 may be performed after the robot coordinate acquisition step S2.

Next, as an example of the work performed by the robotic system 1, as shown in FIG. 1, the work of picking up the workpiece W placed randomly on the loading stand 10 and transporting it to the destination will be described. First, the control device 5 causes the fixed camera 4 to capture an image of the workpiece W placed on the loading stand 10 and acquires fixed camera imaging data. Next, the control device 5 extracts at least one workpiece W from the acquired fixed camera imaging data, and recognizes the position and posture of the extracted workpiece W by, for example, template matching or the like. Next, the control device 5 derives the position and posture of the TCP to be taken for gripping the extracted workpiece W by the tool 24, and moves the robot 2 so that the TCP has the derived position and posture. Next, the control device 5 moves the robot 2 and the tool 24 to grip the workpiece W. Next, the control device 5 moves the robot 2 to transport the workpiece W to the destination. Thus, the transportation of the workpiece W is completed.

Here, the reason for detecting the position and posture of the workpiece W on the loading stand 10 using the fixed camera 4, without using the robot's camera 3 for which calibration has already been completed, is briefly described. It is also possible to image the workpiece Won the loading stand 10 by the robot's camera 3 and detect the position and posture of the workpiece in the robot coordinate system based on the imaging data. However, in order to image the workpiece Won the loading stand 10 by the robot's camera 3, it is necessary to move the robot 2 so that the robot's camera 3 faces the workpiece W on the loading stand 10. On the other hand according to the method of detecting the position and posture of the workpiece W on the loading stand 10 using the fixed camera 4, it is not necessary to move the robot 2, so that the tact time can be shortened.

The robotic system 1 has been described above. The calibration method performed in such the robotic system 1 includes the fixed camera coordinate acquisition step S1 that detects the position of each reference marker M in the fixed camera coordinate system set in the fixed camera 4 from the fixed camera imaging data D1 obtained by imaging the plurality of reference markers M by the fixed camera 4, the robot coordinate acquisition step S2 detects the position of each reference marker M in the robot coordinate system from the robot camera imaging data D2 obtained by imaging the plurality of reference markers M by the robot's camera 3 that is mounted on the robot 2 and that has been calibrated with the robot coordinate system set in the robot 2, and the calibration step S3 associates the fixed camera coordinate system with the robot coordinate system based on the positions of the reference markers M in the fixed camera coordinate system and the positions of the reference markers M in the robot coordinate system. According to such a method, since a touch-up operation as in the related art is not necessary, variation due to the operator does not occur. Therefore, it is possible to effectively suppress decreases or variations in the calibration accuracy.

As described above, in the fixed camera coordinate acquisition step S1, a plurality of reference markers M are imaged in one visual field. Thus, the time required for the fixed camera coordinate acquisition step S1 can be shortened.

As described above, in the robot coordinate acquisition step S2, a plurality of reference markers M are imaged in different visual fields. Accordingly, each reference marker M1 to M9 can be positioned at the central portion of the visual field of the robot's camera 3, and the position of each of the reference markers M1 to M9 in the robot coordinate system can be detected more accurately.

As described above, each reference marker M1 to M9 is imaged in the central portion of the visual field. Accordingly, it is possible to more accurately detect the position of each reference marker M1 to M9 in the robot coordinate system.

As described above, in the robotic system 1 including the robot 2, the robot's camera 3 mounted on the robot 2 and calibrated with a robot coordinate system set in the robot 2, and the fixed camera 4, the calibration device 6 associates the fixed camera coordinate system set in the fixed camera 4 and the robot coordinate system, wherein the position of each reference marker M in the fixed camera coordinate system is detected from the fixed camera imaging data D1 obtained by imaging the plurality of reference markers M by the fixed camera 4, the position of each reference marker M in the robot camera coordinate system is detected from the robot camera imaging data D2 obtained by imaging the plurality of reference markers M by the robot's camera 3, and the fixed camera coordinate system and the robot coordinate system are associated with each other based on the positions of the reference markers M in the fixed camera coordinate system and the positions of the reference markers M in the robot coordinate system. According to such the calibration device 6, since no touch-up operation as in the related art is required, variation due to an operator does not occur. Therefore, it is possible to effectively suppress decreases or variations in the calibration accuracy.

As described above, the robotic system 1 includes the robot 2, the robot's camera 3 mounted on the robot 2 and calibrated with the robot coordinate system set in the robot 2, the fixed camera 4, and the calibration device 6 that associates the fixed camera coordinate system set in the fixed camera 4 with the robot coordinate system. The calibration device 6 detects the position of each reference marker M in the fixed camera coordinate system from the fixed camera imaging data D1 obtained by capturing the plurality of reference markers M by the fixed camera 4, detects the position of each reference marker M in the robot coordinate system from the robot camera imaging data D2 obtained by capturing the plurality of reference markers M by the robot's camera 3, and associates the fixed camera coordinate system with the robot coordinate system based on the positions of the reference markers M in the fixed camera coordinate system and the positions of the reference markers M in the robot coordinate system. According to such the robotic system 1, since a touch-up operation as in the related art is not necessary, variation due to the operator does not occur. Therefore, it is possible to effectively suppress decreases or variations in the calibration accuracy.

The calibration method, the calibration device, and the robotic system according to present disclosure have been described above based on the illustrated embodiments, but the disclosure is not limited thereto, and the configuration of each unit can be replaced with an arbitrary configuration or an arbitrary process having the same function. Other arbitrary configurations or processes may be added to this disclosure.

1. A calibration method comprising:
a fixed camera coordinate acquisition step for detecting a position of each reference marker in a fixed camera coordinate system set in the fixed camera, from fixed camera imaging data obtained by imaging a plurality of reference markers with the fixed camera;
a robot coordinate acquisition step for detecting a position of each reference marker in a robot coordinate system, from robot camera imaging data obtained by imaging a plurality of reference markers with a robot camera that is mounted on a robot and that has been calibrated with a robot coordinate system set in the robot; and
a calibration step of associating the fixed camera coordinate system and the robot coordinate system based on the positions of the reference markers in the fixed camera coordinate system and the positions of the reference markers in the robot coordinate system.

2. The calibration method according to claim 1, wherein
in the fixed camera coordinate acquisition step, the plurality of reference markers are imaged in one visual field.

3. The calibration method according to claim 1, wherein
in the robot coordinate acquisition step, the plurality of reference markers are imaged in different visual fields.

4. The calibration method according to claim 3, wherein
each reference marker is imaged at a central portion of the visual field.

5. A calibration device that associates a fixed camera coordinate system set in a fixed camera with a robot coordinate system in a robotic system, the robotic system including a robot, a robot camera that is mounted on the robot and that has been calibrated using a robot coordinate system set in the robot, and the fixed camera, the calibration device:
detecting a position of each reference marker in the fixed camera coordinate system, from fixed camera imaging data obtained by imaging a plurality of reference markers with the fixed camera,
detecting a position of each reference marker in the robot coordinate system, from robot camera imaging data obtained by imaging the plurality of reference markers with the robot camera, and
associating the fixed camera coordinate system and the robot coordinate system with each other based on positions of the reference markers in the fixed camera coordinate system and positions of the reference markers in the robot coordinate system.

6. A robotic system comprising:
a robot;
a robot camera mounted on the robot and calibrated with a robot coordinate system set in the robot;
a fixed camera; and
a calibration device that associates a fixed camera coordinate system set in the fixed camera with the robot coordinate system; wherein
the calibration device
detects a position of each reference marker in the fixed camera coordinate system from fixed camera imaging data obtained by imaging a plurality of reference markers with the fixed camera,
detects a position of each reference marker in the robot coordinate system from robot camera imaging data obtained by imaging the plurality of reference markers with the robot camera, and
associates the fixed camera coordinate system and the robot coordinate system with each other based on positions of the reference markers in the fixed camera coordinate system and positions of the reference markers in the robot coordinate system.
